(19) United States
(12) Patent Application Publication
(10) Pub. No.: US 2022/0226784 A1
(43) Pub. Date: Jul. 21, 2022

(54) Hollow Fiber Membrane

(71) Applicant: Lubrizol Advanced Materials, Inc., Cleveland, OH (US)

(72) Inventors: Kinkini Roy, North Andover, MA (US); Mark D. Julius, Avon, OH (US); Christopher D. Zook, Akron, OH (US); Donald Naymik, Rocky River, OH (US)

(73) Assignee: Lubrizol Advanced Materials, Inc., Cleveland, OH (US)

(21) Appl. No.: 17/619,378

(22) PCT Filed: Jun. 23, 2020
(86) PCT No.: PCT/US2020/039114

§ 371 Date: Dec. 15, 2021

Related U.S. Application Data
(60) Provisional application No. 62/865,400, filed on Jun. 24, 2019.

(51) Int. Cl. B01D 67/00; B01D 69/08; B01D 69/02; B01D 71/30; B01D 71/54; B01D 71/82

(52) U.S. Cl. CPC B01D 67/0011; B01D 69/08; B01D 69/02; B01D 71/30; B01D 2325/30; B01D 71/82; B01D 2323/12; B01D 2323/18; B01D 2325/22; B01D 71/54

(57) ABSTRACT

The disclosed technology relates to hollow fiber membranes prepared from a dope solution containing a polymer of vinyl chloride, such as chlorinated polyvinyl chloride, and a thermoplastic polyurethane.

### BACKGROUND OF THE INVENTION

The disclosed technology relates to hollow fiber membranes prepared from a composition containing a polymer of vinyl chloride, such as chlorinated polyvinyl chloride and a thermoplastic polyurethane.

Membrane separation technology is an energy saving, high efficiency physical technology for separations. Membranes have a wide range of applications from drinking water purification, to industrial waste-water purification. Current commercial membranes are made from materials that degrade or lose efficiency when exposed to harsh chemicals, such as the bleach solutions used to clean purification systems. As such, the market needs a stable, chemically and temperature resistant membrane.

### SUMMARY OF THE INVENTION

The disclosed technology, therefore, solves the problem of chemical degradation of hollow fiber membranes by providing a hollow fiber membrane containing a composition containing a polyvinyl chloride polymer and a thermoplastic polyurethane. It has been found that the use of a thermoplastic polyurethane in the hollow fiber membrane provides flexibility to the hollow fiber membrane and prevents breakage of the hollow fiber membrane.

One aspect of the invention is directed to a dope solution for preparing a hollow fiber membrane. The dope solution can include at least one polymer of vinyl chloride, at least one thermoplastic polyurethane, at least one pore forming agent, and at least one solvent.

In an example embodiment, the polymer of vinyl chloride can be present in the dope solution at a concentration of from about 10 to about 40 wt. %. The thermoplastic polyurethane can be present at a concentration of from about 0.1 to about 15 wt. %. The dope solution can also contain the pore forming agent at a concentration of from about 1 to about 20 wt. %. The solvent may be present at a concentration of from about 25 to about 88.9 wt. %.

The dope solution can also contain processing aids such as surfactants, drying agents, catalysts, co-solvents, such as polar aprotic solvents, or any combination thereof.

Another aspect of the invention is directed toward a hollow fiber membrane. The hollow fiber membrane includes a hollow fiber extruded from the dope solution described herein.

In one aspect, the hollow fiber membrane can have pores suitable for microfiltration. In another aspect, the hollow fiber membrane can have pores suitable for ultrafiltration. In a further aspect, the hollow fiber membrane can have pores suitable for nanofiltration.

The hollow fiber membrane can have either an asymmetric pore distribution or symmetric pore distribution. Likewise, the hollow fiber membrane can have skin layer or no skin layer. In an embodiment, the hollow fiber membrane can have an integral skin layer.

Another aspect of the invention is directed toward a method for manufacturing the hollow fiber membrane. The method can include preparing a dope solution as described herein followed by extruding the dope solution. The dope solution can be extruded into air or extruded into air followed by a coagulant. The dope solution can also be extruded directly into a coagulant.

An additional aspect of the invention is directed toward a method of treating an effluent stream by filtering the effluent through the hollow fiber membrane described herein. In an embodiment, the effluent stream can include a gas in gas stream. In an embodiment, the effluent stream can include a gas in liquid stream.

In an embodiment, the effluent stream can include a liquid in liquid stream. In another embodiment, the effluent stream can include suspended solids in liquid stream.

### DETAILED DESCRIPTION OF THE INVENTION

Various preferred features and embodiments will be described below by way of non-limiting illustration.

### Dope Solution

There is provided, in one aspect of the disclosed technology, a dope solution for preparing a hollow fiber membrane. The dope solution can include at least one polymer of vinyl chloride, at least one thermoplastic polyurethane, at least one pore forming agent, and at least one solvent.

The dope solution provided herein contains, at least in part, a polymer of vinyl chloride. Polymers of vinyl chloride include, for example, polyvinyl chloride (“PVC”) or chlorinated polyvinyl chloride (“CPVC”), which may collectively be referred to herein as “(C)PVC.”

(C)PVC resins are both known to the art and to the literature and are commercially available. CPVC can be prepared by chlorinating PVC resin and there are considerations pertaining to the PVC, whether it being used in the dope solution itself, and ultimately the hollow fiber membrane itself, or as a precursor from which a CPVC product may be derived for use in the dope solution/hollow fiber membrane. The molecular weight of PVC suitable for the dope solution/membrane, as indicated by inherent viscosity (I.V.) measurement per ASTM D1243, should generally range from about 0.4 to about 1.4 at the extremes. Desirably, the I.V. of the PVC employed (itself, or as precursor to the CPVC) falls within a range of from about 0.6 to about 1.4, or from about 0.5 to 1.3, or even from about 0.54 to 1.2, or about 0.6 to 1.1, and in some embodiments from about 0.65 to 0.90 or 0.92, or even from about 0.65 to 1.

(C)PVC resin suitable for the dope solution/membrane can have a chlorine content of from about 56 to about 72 wt. % based on the weight of the polymer, or from about 58 to about 71 wt. %, or about 59 to about 70 wt. %. In terms of the various resins, PVC resin suitable for the dope solution/membrane can have a chlorine content of about 57 to about 58 weight percent (wt. %), such as from about 56 to about 59 wt. %. CPVC resin suitable for the dope solution/membrane can include CPVC having a chlorine content of from about 59.0 to about 72.0 wt. %, or from about 60.0 to about 70.0 or 71.0 wt. %, and even from about 63.0 to about 68.0 or 69.0 wt. %, or between about 64.0 or 65.0 and 67.0 wt. %.

The dope solution can contain (C)PVC (i.e., either PVC or CPVC or a combination thereof) at a concentration of from about 10 to about 40 wt. %, or for example, about 11 to 30 wt. %, or even from about 12 to 24 wt. %.

The dopes solution will also contain from about 0.1 to about 15 wt. % or from about 1.05 to about 12 wt. %, or 1.1 to 10 wt. % of a thermoplastic polyurethane (“TPU”).

It is well understood by those skilled in the art that “polyurethane” is a generic term used to describe polymers obtained by reacting isocyanates with at least one hydroxyl-containing compound, amine-containing compound, or mixture thereof. It also is well understood by those skilled in the art that polyurethanes can also include allophanate, biuret, carbodiimide, oxazolidinyl, isocyanurate, uretdione, and other linkages in addition to urethane and urea linkages.

The TPUs suitable for the dope solution/membrane will include at least one polyisocyanate. Polyisocyanates have an average of about two or more isocyanate groups, preferably an average of about two to about four isocyanate groups and include aliphatic, cycloaliphatic, araliphatic, and aromatic polyisocyanates, used alone or in mixtures of two or more. Diisocyanates are more preferred.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates include dicyclohexylmethane diisocyanate, (commercially available as DesmodurTM W from Bayer Corporation), isophorone diisocyanate, 1,4-cyclohexane diisocyanate, 1,3-bis-(isocyanatomethyl) cyclohexane, and the like. Preferred cycloaliphatic polyisocyanates include dicyclohexylmethane diisocyanate and isophorone diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate), toluene diisocyanate, their isomers, naphthalene diisocyanate, and the like. A preferred aromatic polyisocyanate is toluene diisocyanate.

The TPUs suitable for the dope solution/membrane can also include at least one active hydrogen-containing compound. The term “active hydrogen-containing” refers to compounds that are a source of active hydrogen and that can react with isocyanate groups via the following reaction: —NCO+H—X→—NH—C(═O)—X. Examples of suitable active hydrogen-containing compounds include but are not limited to polyols, poythiols and polyamines.

The term “polyol” denotes any high molecular weight product having an average of about two or more hydroxyl groups per molecule. Examples of such polyols include higher polymeric polyols such as polyester polyols and polyether polyols, as well as polyhydroxy polyester amides, hydroxyl-containing polycaprolactones, hydroxyl-containing acrylic interpolymers, hydroxyl-containing epoxides, polyhydroxy polycarbonates, polyhydroxy polyacetals, polyhydroxy polythioethers, polysiloxane polyols, ethoxylated polysiloxane polyols, polybutadiene polyols and hydrogenated polybutadiene polyols, polyacrylate polyols, halogenated polyesters and polyethers, and the like, and mixtures thereof. The polyester polyols, polyether polyols, polycarbonate polyols, polysiloxane polyols, and ethoxylated polysiloxane polyols are preferred.

A preferred polyester polyol is a diol. Preferred polyester diols include poly(butanediol adipate); hexane diol adipic acid and isophthalic, acid polyesters such as hexane adipate isophthalate polyester; hexane diol neopentyl glycol adipic acid polyester diols, as well as propylene glycol maleic anhydride adipic acid polyester diols, and hexane diol neopentyl glycol fumaric acid polyester diols.

Polyether diols may be substituted in whole or in part for the polyester diols. Preferred polyethers include poly(propylene glycol), polytetrahydrofuran, and copolymers of poly(ethylene glycol) and poly(propylene glycol).

Polycarbonates include those obtained from the reaction of (A) diols such 1,3-propanediol, 1,4-butanediol, 1,6-hexanediol, diethylene glycol, triethylene glycol, tetraethylene glycol, and the like, and mixtures thereof with (B) diarylcarbonates such as diphenylcarbonate or phosgene.

Polyacetals include the compounds that can be prepared from the reaction of (A) aldehydes, such as formaldehyde and the like, and (B) glycols such as diethylene glycol, triethylene glycol, ethoxylated 4,4′-dihydroxy-diphenyldimethylmethane, 1,6-hexanediol, and the like. Polyacetals can also be prepared by the polymerization of cyclic acetals.

Instead of a long-chain polyol, a long-chain amine may also be used to prepare the TPU. Suitable long-chain amines include polyester amides and polyamides, such as the predominantly linear condensates obtained from reaction of (A) polybasic saturated and unsaturated carboxylic acids or their anyhydrides, and (B) polyvalent saturated or unsaturated aminoalcohols, diamines, polyamines, and the like, and mixtures thereof.

Diamines and polyamines are among the preferred compounds useful in preparing the aforesaid polyester amides and polyamides. Suitable diamines and polyamines include 1,2-diaminoethane, 1,6-diaminohexane, 2-methyl-1,5-pentanediamine, 2,2,4-trimethyl-1,6-hexanediamine, 1,12-diaminododecane, 2-aminoethanol, 2-[(2-aminoethyl)amino]-ethanol, piperazine, 2,5-dimethylpiperazine, 1-amino-3-aminomethyl-3,5,5-trimethylcyclohexane (isophorone diamine or IPDA), bis-(4-aminocyclohexyl)-methane, bis-(4-amino-3-methyl-cyclohexyl)-methane, 1,4-diaminocyclohexane, 1,2-propylenediamine, hydrazine, urea, amino acid hydrazides, hydrazides of semicarbazidocarboxylic acids, bis-hydrazides and bis-semicarbazides, diethylene triamine, triethylene tetramine, tetraethylene pentamine, pentaethylene hexamine, N,N,N-tris-(2-aminoethyl)amine, N-(2-piperazinoethyl)-ethylene diamine, N,N′-bis-(2-aminoethyl)-piperazine, N,N,N′-tris-(2-aminoethyl)ethylene diamine, N-[N-(2-aminoethyl)-2-aminoethyl]-N′-(2-aminoethyl)-piperazine, N-(2-aminoethyl)-N′-(2-piperazinoethyl)-ethylene diamine, N,N-bis-(2-aminoethyl)-N-(2-piperazinoethyl)amine, N,N-bis-(2-piperazinoethyl)-amine, polyethylene imines, iminobispropylamine, guanidine, melamine, N-(2-aminoethyl)-1,3-propane diamine, 3,3′-diaminobenzidine, 2,4,6-triaminopyrimidine, polyoxypropylene amines, tetrapropylenepentamine, tripropylenetetramine, N,N-bis-(6-aminohexyl)amine, N,N′-bis-(3-aminopropyl)ethylene diamine, and 2,4-bis-(4′-aminobenzyl)-aniline, and the like, and mixtures thereof. Preferred diamines and polyamines include 1-amino-3-aminomethyl-3,5,5-trimethyl-cyclohexane (isophorone diamine or IPDA), bis-(4-aminocyclohexyl)-methane, bis-(4-amino-3-methylcyclohexyl)-methane, ethylene diamine, diethylene triamine, triethylene tetramine, tetraethylene pentamine, and pentaethylene hexamine, and the like, and mixtures thereof. Other suitable diamines and polyamines include Jeffamine® D-2000 and D-4000, which are amine-terminated polypropylene glycols, differing only by molecular weight, and which are available from Huntsman Chemical Company.

The TPU may include side-chains prepared, for example, from alkylene oxides. As used herein, the term “alkylene oxide” includes both alkylene oxides and substituted alkylene oxides having 2 to 10 carbon atoms. The active hydrogen-containing compounds can have poly(alkylene oxide) side chains sufficient in amount to comprise about 12 wt. % to about 80 wt. %, preferably about 15 wt. % to about 60 wt. %, and more preferably about 20 wt. % to about 50 wt. %, of poly(alkylene oxide) units in the TPU on a dry weight basis. At least about 50 wt. %, preferably at least about 70 wt. %, and more preferably at least about 90 wt. % of the poly(alkylene oxide) side-chain units comprise poly(ethylene oxide), and the remainder of the side-chain poly(alkylene oxide) units can comprise alkylene oxide and substituted alkylene oxide units having from 3 to about 10 carbon atoms, such as propylene oxide, tetramethylene oxide, butylene oxides, epichlorohydrin, epibromohydrin, allyl glycidyl ether, styrene oxide, and the like, and mixtures thereof.

Preferably such active hydrogen-containing compounds provide less than about 25 wt. %, more preferably less than about 15 wt. % and most preferably less than about 5 wt. % poly(ethylene oxide) units in the backbone (main chain) based upon the dry weight of TPU. Preferably the amount of the side-chain units is (i) at least about 30 wt. %

when the molecular weight of the side-chain units is less than about 600 grams/mole, (ii) at least about 15 wt. % when the molecular weight of the side-chain units is from about 600 to about 1,000 grams/mole, and (iii) at least about 12 wt. % when the molecular weight of said side-chain units is more than about 1,000 grams/mole. Mixtures of active hydrogen-containing compounds having such poly(alkylene oxide) side chains can be used with active hydrogen-containing compounds not having such side chains.

Preferably the TPU also have reacted therein at least one active hydrogen-containing compound not having said side chains and typically ranging widely in molecular weight from about 50 to about 10,000 grams/mole, preferably about 200 to about 6,000 grams/mole, and more preferably about 300 to about 3,000 grams/mole. Suitable active-hydrogen containing compounds not having said side chains include any of the amines and polyols described.

The ratio of isocyanate to active hydrogen in the TPU typically ranges from about 1.3/1 to about 2.5/1, preferably from about 1.5/1 to about 2.1/1, and more preferably from about 1.7/1 to about 2/1.

The TPU may also include compounds having at least one crosslinkable functional group. Compounds having at least one crosslinkable functional group include those having carboxylic, carbonyl, amine, hydroxyl, and hydrazide groups, and the like, and mixtures of such groups. The typical amount of such optional compound is up to about 1 milliequivalent, preferably from about 0.05 to about 0.5 milliequivalent, and more preferably from about 0.1 to about 0.3 milliequivalent per gram of TPU on a dry weight basis.

The preferred monomers for incorporation into the TPU are hydroxy-carboxylic acids having the general formula (HO)ₓQ(COOH)_{y}, wherein Q is a straight or branched hydrocarbon radical having 1 to 12 carbon atoms, and x and y are 1 to 3. Examples of such hydroxy-carboxylic acids include citric acid, dimethylolpropionic acid (DMPA), dimethylol butanoic acid (DMBA), glycolic acid, lactic acid, malic acid, dihydroxymalic acid, tartaric acid, hydroxypivalic acid, and the like, and mixtures thereof. Dihydroxy-carboxylic acids are more preferred with dimethylolpropanoic acid (DMPA) being most preferred.

Other suitable compounds providing crosslinkability include thioglycolic acid, 2,6-dihydroxybenzoic acid, and the like, and mixtures thereof.

The formation of the TPU may be achieved without the use of a catalyst. However, a catalyst is preferred in some instances. Examples of suitable catalysts include stannous octoate, dibutyl tin dilaurate, and tertiary amine compounds such as triethylamine and bis-(dimethylaminoethyl) ether, morpholine compounds such as β,β′-dimorpholinodiethyl ether, bismuth carboxylates, zinc bismuth carboxylates, iron (III) chloride, potassium octoate, potassium acetate, and DABCO® (diazabicyclo[2.2.2]octane), from Air Products. The preferred catalyst is a mixture of 2-ethylhexanoic acid and stannous octoate, e.g., FASCAT® 2003 from Elf Atochem North America. The amount of catalyst used is typically from about 5 to about 200 parts per million of the total weight of prepolymer reactants.

Optional neutralization of the prepolymer having pendant carboxyl groups converts the carboxyl groups to carboxylate anions, thus having a water-dispersibility enhancing effect. Suitable neutralizing agents include tertiary amines, metal hydroxides, ammonium hydroxide, phosphines, and other agents well known to those skilled in the art.

Tertiary amines and ammonium hydroxide are preferred, such as triethyl amine (TEA), dimethyl ethanolamine (DMEA), N-methyl morpholine, and the like, and mixtures thereof. It is recognized that primary or secondary amines may be used in place of tertiary amines, if they are sufficiently hindered to avoid interfering with the chain extension process.

The TPU may include a chain extender. As a chain extender, at least one of water, inorganic or organic polyamine having an average of about 2 or more primary and/or secondary amine groups, polyalcohols, ureas, or combinations thereof is suitable for use in the present invention. Suitable organic amines for use as a chain extender include diethylene triamine (DETA), ethylene diamine (EDA), meta-xylylenediamine (MXDA), aminoethyl ethanolamine (AEEA), 2-methyl pentane diamine, and the like, and mixtures thereof. Also suitable for practice in the present invention are propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, sulfonated primary and/or secondary amines, and the like, and mixtures thereof. Suitable inorganic amines include hydrazine, substituted hydrazines, and hydrazine reaction products, and the like, and mixtures thereof. Suitable polyalcohols include those having from 2 to 12 carbon atoms, preferably from 2 to 8 carbon atoms, such as ethylene glycol, diethylene glycol, neopentyl glycol, butanediols, hexanediol, and the like, and mixtures thereof. Suitable ureas include urea and it derivatives, and the like, and mixtures thereof. Hydrazine is preferred and is most preferably used as a solution in water.

The amount of chain extender typically ranges from about 0.5 to about 0.95 equivalents based on available isocyanate.

The TPU can be prepared in the presence of a plasticizer. Plasticizers well known to the art can be selected for use in this invention according to parameters such as compatibility with the particular polyurethane and desired properties of the final composition, such as those listed in WIPO Publication WO 02/08327 A1 (incorporated herein by reference in its entirety). The plasticizers typically are used in amounts from about 2 wt. % to about 100 wt. %, preferably from about 5 to about 50 wt. %, and more preferably from about 5 to about 30 wt. %, based on polyurethane dry weight. The optimum amount of plasticizer is determined according to the particular application, as is well known to those skilled in the art.

Suitable plasticizers include ester derivatives of such acids and anhydrides as adipic acid, azelaic acid, benzoic acid, citric acid, dimer acids, fumaric acid, isobutyric acid, isophthalic acid, lauric acid, linoleic acid, maleic acid, maleic anyhydride, melissic acid, myristic acid, oleic acid, palmitic acid, phosphoric acid, phthalic acid, ricinoleic acid, sebacic acid, stearic acid, succinic acid, 1,2-benzenedicarboxylic acid, and the like, and mixtures thereof. Also suitable are epoxidized oils, glycerol derivatives, paraffin derivatives, sulfonic acid derivatives, and the like, and mixtures thereof and with the aforesaid derivatives. Specific examples of such plasticizers include diethylhexyl adipate, heptyl nonyl adipate, diisodecyl adipate, the adipic acid polyesters, dicapryl adipate, dimethyl azelate, diethylene glycol dibenzoate and dipropylene glycol dibenzoate, polyethylene glycol dibenzoate, 2,2,4-trimethyl-1,3-pentanediol monoisobutyrate benzoate, 2,2,4-trimethyl-1,3-pentanediol diisobutyrate, methyl (or ethyl, or butyl) phthalyl ethyl glycolate, triethyl citrate, dibutyl fumarate, 2,2,4-trimethyl-1,3-pentanediol diisobutyrate, methyl laurate, methyl linoleate, di-n-butyl maleate, tricapryl trimellitate, heptyl nonyl trimellitate, triisodecyl trimellitate, triisononyl trimellitate, isopropyl myristate, butyl oleate, methyl palmitate, tricresyl phosphate, dimethyl phthalate, diethyl phthalate, dibutyl phthalate, diisobutyl phthalate, di-2-ethylhexyl phthalate, octyl decyl phthalate, diisodecyl phthalate, heptyl nonyl phthalate, diundecyl phthalate, ditridecyl phthalate, dicyclohexyl phthalate, diphenyl phthalate, butyl benzyl phthalates such as the n-butylbenzyl ester of o-phthalic acid, isodecyl benzyl phthalate, alkyl (C₇/C₉) benzyl phthalate, dimethoxyethyl phthalate, 7-(2,6,6,8-tetramethyl-4-oxa-3-oxo-nonyl) benzyl phthalate, di-2-ethylhexyl sebacate, butyl ricinoleate, dimethyl sebacate, methyl stearate, diethyl succinate, the butyl phenylmethyl ester of 1,2-benzenedicarboxylic acid, epoxidized linseed oil, glycerol triacetate, chloroparaffins having about 40% to about 70% Cl, o,p-toluenesulfonamide, N-ethyl p-toluene sulfonamide, N-cyclohexyl p-toluene sulfonamide, sulfonamide-formaldehyde resin, and the like, and mixtures thereof. Other suitable plasticizers known to those skilled in the art include castor oil, sunflower seed oil, soybean oil, aromatic petroleum condensate, partially hydrogenated terphenyls, silicone plasticizers such as dimethicone copolyol esters, dimethiconol esters, silicone carboxylates, guerbet esters, and the like, alone or as mixtures with other plasticizers.

Examples of suitable reactive plasticizers include compositions and mixtures having ethylenic unsaturation, such as triallyl trimellitate (TATM), Stepanol PD-200LV (a mixture of (1) unsaturated oil and (2) polyester diol reaction product of o-phthalic acid and diethylene glycol from Stepan Company), and the like, and mixtures thereof. Other suitable reactive plasticizers include epoxidized plasticizers, including certain monofuctional and polyfunctional glycidyl ethers such as polyglycidyl ether of castor oil and dimer acid diglycidyl ether, and the like, and mixtures thereof.

Examples of suitable flame retardant plasticizers include phosphorus-based plasticizers such as cyclic phosphates, phosphites, and phosphate esters, tricresyl phosphate, trixylenyl phosphate, cyclic phosphate esters, tar acid, cresol, xylyl, phenol phosphates, and trixylyl phosphate; halogenated aryl esters; chlorinated biphenyl, 2-ethylhexyl diphenyl phosphate, isodecyl diphenyl phosphate, triphenyl phosphate, cresyl diphenyl phosphate, p-t-butylphenyl diphenyl phosphate, triphenyl phosphite, and the like. Other examples of phosphorus-based plasticizers include chlorinated alkyl phosphate esters chloro alkyl diphosphate ester; alkyl phosphates and phosphites such as tributyl phosphate, tri-2-ethylhexyl phosphate, and triisoctyl phosphite; other organophosphates and organophosphites such as tributoxy ethylphosphate; other phosphates and phosphonates such as chlorinated diphosphate and chlorinated polyphosphonate; and the like. Mixtures can also be used.

Examples of suitable wetting, emulsifying, and conditioning plasticizers include alkyloxylated fatty alcohol phosphate esters such as oleth-2 phosphate, oleth-3 phosphate, oleth-4 phosphate, oleth-10 phosphate, oleth-20 phosphate, ceteth-8 phosphate, ceteareth-5 phosphate, ceteareth-10 phosphate, PPG ceteth-10 phosphate, and the like, and mixtures thereof.

Other additives well known to those skilled in the art can be used to aid in preparation of the TPU. Such additives include surfactants, stabilizers, defoamers, antimicrobial agents, antioxidants, UV absorbers, carbodiimides, and the like.

The TPU can be processed by methods well known to those skilled in the art to make articles having excellent breathability, i.e., moisture vapor transmission rates (“MVTR”). Suitable MVTR's typically are an upright MVTR of at least about 500 grams/m²/24 hours, preferably at least about 600 grams/m²/24 hours, and more preferably at least about 700 grams/m²/24 hours grams/m²/24 hours. The term “breathable” is used herein to denote such excellent MVTR. Similarly, the term “breathability” is used as an indication of the MVTR of a particular composition or article and is described more particularly as excellent (above about 500 grams/m²/24 hours) or inferior (below about 500 grams/m²/24 hours).

In an embodiment, the TPU can be prepared by:
(A) reacting to form an isocyanate-terminated prepolymer (1) at least one polyisocyanate having an average of about two or more isocyanate groups; (2) at least one active hydrogen-containing compound comprising (a) poly(alkylene oxide) side-chain units in an amount comprising about 12 wt. % to about 80 wt. % of said TPU, wherein (i) alkylene oxide groups in said poly(alkylene oxide) side-chain units have from 2 to 10 carbon atoms and are unsubstituted, substituted, or both unsubstituted and substituted, (ii) at least about 50 wt. % of said alkylene oxide groups are ethylene oxide, and (iii) said amount of said side-chain units is at least about 30 wt. % when the molecular weight of said side-chain units is less than about 600 grams/mole, at least about 15 wt. % when the molecular weight of said side-chain units is from about 600 to about 1,000 grams/mole, and at least about 12 wt. % when the molecular weight of said side-chain units is more than about 1,000 grams/mole, and (b) poly(ethylene oxide) main-chain units in an amount comprising less than about 25 wt. % of said TPU; (3) preferably at least one other active hydrogen-containing compound not containing poly(alkylene oxide) side-chain units; and (4) optionally at least one compound having at least one crosslinkable functional group, in order to form an isocyanate-terminated pre-polymer;
(B) dispersing said prepolymer in water, and chain extending said pre-polymer by reaction with at least one of water, inorganic or organic polyamine having an average of about 2 or more primary and/or secondary amine groups, polyalcohols, ureas, or combinations thereof; and
(C) thereafter further processing the chain-extended dispersion of step (B) in order to form a composition or article having an upright moisture vapor transmission rate (MVTR) of more than about 500 gms/m²/24 hr.

The dope solution provided herein also contains at least one pore forming agent. A pore-forming agent is a substance that is soluble in the blend solvent (described below) and that may or may not be soluble in the coagulation solvent (described below). The presence of a pore-forming agent can provide for greater control over the size and distribution of pores in the hollow fiber membrane that is formed from the coagulation in the coagulation bath. The pore-forming agent in its pure state at room temperature can be a liquid, but is often a water-soluble solid. Examples of pore-forming agents suitable for the dope solution/membrane include salts and phenols. For example, salts of alkali metals, alkaline earth metals, transition metals or ammonium with halides or carbonates can be used as pore-forming agents. Specific examples include ammonium chloride, calcium chloride, magnesium chloride, lithium chloride, sodium chloride, zinc chloride, calcium carbonate, magnesium carbonate, sodium carbonate, and sodium bicarbonate. Sodium citrate can also be used as a pore forming agent. Examples of phenols include phenol, ethylphenol, catechol, resorcinol, hydroquinone and methoxyphenol. Other conventional pore-forming agents include non-solvent liquids and also include polymers such as poly(vinyl alcohol), poly(vinyl pyrrolidone), glycols, such as as polyethylene glycol, oxide copolymers, such as polyethylene-polyethylene oxide copolymers, and the like, and hydroxyalkylcellulose polymers.

The molecular weight of the pore forming agent, in some embodiments, can have an effect on the size of the pores formed in the hollow fiber membrane.

Normally the pore size of membranes increases with increasing molecular weight of the pore former, but this is not always a hard rule. Sometimes, pore size/pore distribution reaches an optimum value and it does not increase with an increase in pore former molecular weight. The effect of molecular weight varies from pore former to pore former.

In an embodiment, the pore forming agent can be a polyvinyl pyrrolidone having a molecular weight of from about 8000 to about 150,000. In certain instances, such as for preparing a microfiltration or ultrafiltration membrane, the pore former may be a polyvinyl pyrrolidone having a molecular weight of from about 40,000 to about 150,000. In other instances, such as for preparing a nanofiltration membrane, the polyvinyl pyrrolidone pore forming agent may have a molecular weight of from about 8000 to about 40,000.

In an embodiment, the pore forming agent can be a poly(ethylene glycol)-block-poly(propylene glycol)-block-poly(ethylene glycol) copolymer having a molecular weight of from about 1000 to about 6000. In certain instances, such as for preparing a microfiltration membrane, the pore former may be a poly(ethylene glycol)-block-poly(propylene glycol)-block-poly(ethylene glycol) copolymer having a molecular weight of from about 3000 to about 6000. In other instances, such as for preparing an ultrafiltration membrane, the poly(ethylene glycol)-block-poly(propylene glycol)-block-poly(ethylene glycol) copolymer pore forming agent may have a molecular weight of from about 2000 to about 4000. In other instances, such as for preparing a nanofiltration membrane, the poly(ethylene glycol)-block-poly(propylene glycol)-block-poly(ethylene glycol) copolymer pore forming agent may have a molecular weight of from about 1000 to about 2000.

In an embodiment, the pore forming agent can be a polyethylene glycol having a molecular weight of from about 200 to about 20,000. In certain instances, such as for preparing a microfiltration membrane, the pore former may be a polyethylene glycol having a molecular weight of from about 8000 to about 20,000. In other instances, such as for preparing an ultrafiltration or nanofiltration membrane, the polyethylene glycol pore forming agent may have a molecular weight of from about 200 to about 10,000.

The pore forming agent can present in the dope solution at a concentration of from about 1 to about 20 wt. %, or from about 2 to about 18 wt. %, or from about 4 to about 16 wt. %, or even from about 5 to about 15 wt. % or about 5 to about 10 wt. %.

The dope solution also includes at least one solvent. The solvent is preferably a polar aprotic solvent such as N-methyl pyrrolidone (NMP), N,N-dimethyl acetamide (DMAC), dimethyl formamide (DMF), methyl ethyl ketone (MEK), methyl isobutyl ketone (MIBK), cyclohexanone, tetrahydrofuran (THF), methanol, acetone, and dimethyl sulfoxide (DMSO). Some polar protic solvents may be employed as well, as such as, for example, isopropyl alcohol (IPA). The solvent for the blend can be a mixture of these solvents and may also include one or more other liquids that are non-solvents for (C)PVC or the further polymers. The polymers can be mixed with portions of the solvent separately and then mixed, they can be mixed with the solvent sequentially, or the polymers can be mixed with the solvent simultaneously. It may be desirable to heat the solvent-polymer mixture while mixing or agitating to facilitate complete dissolution of the polymers. The solvent may be present in the dope solution at a concentration of from about 25 to about 88.9 or 90 wt. %, or from about 25 or 30 to about 70 wt. %, or even from about 35 to about 65 wt. % or about 40 to about 60 wt. %.

The dope solution can also include processing aids, such as surfactants, drying agents, catalysts, co-solvents, such as polar aprotic solvents, or any combination thereof. Among other things, processing aids can be employed to modify surface properties or further increase performance of a hollow fiber membrane prepared from the dope solution, for example, to improve fouling resistance. When present, the processing aids, collectively, can be in the dope solution at a concentration of about 0.1 to about 10 wt. %, or from about 0.5 to about 8 wt. %, or even from about 1 to about 6 wt. %.

Exemplary processing aids include phosphoramides, dialkyl sulfoxides, metal chelate additives containing a bidentate ligand and a metal atom or metal ion, e.g., acetylacetonate (acac) or fluorinated acetylacetonate, beta-diketonates or fluorinated beta-diketonates, zeolites, fullerenes, carbon nanotubes, and inorganic mineral compounds.

The surfactant(s) can be selected from among nonionic, cationic, anionic, and zwitterionic surfactants depending on the chemistry of the other additives. For example, a cationic surfactant would not be selected when anionic additives are being used. When present, the amount of surfactant can be from about 0.005 wt. % wt. % to about 0.5 wt. % wt. %, or from about 0.01 wt. % to about 0.25 wt. %, or from about 0.05% to about 0.25%.

In some embodiments, one or more drying agents can be included in the dope solution. Drying agents can include, for example, hydrophobic organic compounds, such as a hydrocarbon or an ether, glycerin, citric acid, glycols, glucose, sucrose, triethylammonium camphorsulfonate, triethylammonium benzenesulfonate, triethylammonium toluenesulfonate, triethylammonium methane sulfonate, ammonium camphor sulfonate, and ammonium benzene sulfonate, and those described in U.S. Pat. Nos. 4,855,048; 4,948,507; 4,983,291; and 5,658,460. When present, the amount of drying agent can be from about 2 wt. % to about 10 wt. %, or from about 3 wt. % to about 5 wt. %.

Catalysts can be included in the dope solution as a processing aid. In some embodiments, a catalyst can include diethylamine, triethylamine, ethylene diamine, triethanolamine, diethanolamine, ethanolamine, dimethylaminopyridine, or combinations thereof. In some embodiments, the catalyst can be an acid catalyst or a base catalyst. An acid catalyst can be an inorganic acid, an organic acid, a Lewis acid, or a quaternary ammonium salt or an acid salt of ammonia or a primary, secondary or tertiary amine. When present, the amount of catalyst in the dope solution can be from about 0.001 wt. % to about 0.5 wt. %, or from about 0.005 wt. % to about 0.25 wt. %.

Other additives conventionally employed in CPVC compounds can also be added to the dope solution as needed. Conventional CPVC additives known in the art as well any other additives may be used, provided that the additive does not alter the physical properties and the process stability associated with the novel dope solution and the membranes made therefrom. Examples of additives which can be used include antioxidants, lubricants, stabilizers including both metal based and organic based, impact modifiers, pigments, glass transition enhancing additives, processing aids, fusion aids, fillers, fibrous reinforcing agents, antistatic agents, etc.

### Hollow Fiber Membrane

In another aspect of the invention, there is provided a hollow fiber membrane, or simply “membrane” for short. In the art, membranes may be in a hollow fiber or tubular form, or in the form of a flat sheet. Flat sheet membranes may be rolled or wound into tubular or spiral wound configurations. However, such tubular or spiral wound configurations from a flat sheet membrane are distinct from hollow fibers discussed herein, which are prepared directly in a fiber or tubular form by extrusion. As used herein the term “membrane” is used to refer specifically to a hollow fiber or tubular membrane having a selectively permeable barrier or partition prepared by extrusion. Such membranes have a number of uses, and in particular for filtration, where permeability is based on the hollow fiber membrane being porous.

The hollow fiber membrane (or simply “membrane”) may be extruded from the dope solution described above to obtain a hollow fiber membrane having pores suitable for use in microfiltration, ultrafiltration, or nano-filtration end uses. That is to say that the hollow fiber membrane may have pores suitable for microfiltration ranging in size from about 0.1 to 100 μm, or about 0.5 to 100 μm, or even from about 1 to 100 μm; or pores suitable for ultrafiltration ranging in size from about 0.01 to 2 μm, or about 0.1 to 1 μm; or pores suitable for nano-filtration ranging in size from about 0.001 to 0.5 μm, or about 0.001 to 0.1 μm.

The pores in the hollow fiber membrane may be distributed through the hollow fiber membrane symmetrically, meaning the distribution of pores within the hollow fiber membrane are on average of about the same size and spacing, or asymmetrically. The pore structure in an asymmetric membrane exhibits a gradient where the size of the pores gradually changes from large pores at the filtrate side of the hollow fiber membrane to small pores at the effluent side. The smaller the pores the more the effluent side layer appears as a “skin” layer on the effluent side of the hollow fiber membrane. Where some asymmetric membranes may have a skin that is integral with the hollow fiber membrane, other asymmetric membranes have a skin that is coated onto a substrate to form the hollow fiber membrane. In either fashion, the asymmetric membrane may have a 0.01-5 micron layer over a more porous 100-300 micron thick layer. In some embodiments the pores in the asymmetric membrane do not grade out small enough to form a skin layer, in which case the hollow fiber membrane does not contain a skin layer. The hollow fiber membrane provided herein may have an asymmetric structure without a skin layer. The hollow fiber membrane may also have an asymmetric structure with a skin layer. Where the hollow fiber membrane includes a skin layer, the skin layer may be integral to the hollow fiber membrane or coated onto the hollow fiber membrane.

### Process for Preparing the Hollow Fiber Membrane

A further aspect of the invention provided is a method for manufacturing a hollow fiber membrane.

The first step of the method involves preparing the dope solution, as described above, by dissolving the ingredients into the dope solution solvents. The dope solution can be prepared at elevated temperature, such as 50 to 60° C. to aid in quicker dissolution. After mixing the dope solution is degassed, for example, by application of a vacuum to the solution.

Once the dope solution is prepared, it is extruded into a hollow fiber.

Extrusion is a well-known process that, briefly, involves pushing a material through a die of the desired cross-section to obtain a form of the desired profile. In an embodiment, the dope solution can be extruded through a spinneret.

The extruded fiber can then be subjected to a phase inversion process. Phase inversion is a known process resulting in a controlled transformation of a polymer from a liquid to a solid in a quenching environment.

The term quenching environment means any environment that causes a polymer to precipitate from a dissolved state into a solidified state. The quenching of the extruded fiber can occur in a single procedure or in more than one procedure.

The phase inversion process includes, for example, vapor phase precipitation, evaporation and immersion precipitation processes, in which the polymer of the hollow fiber membrane precipitates from a solvent solution in some manner. The specifics of each process are subject to, for example, the types and amounts of solvents employed, and the temperatures used.

In one embodiment, the extruded fiber can be immersed, either immediately or after some delay, in a quenching environment for a sufficient period to allow phase inversion, such as 1 minute to 4 hours.

For example, the quenching of an extruded fiber can involve simply moving the fiber into a coagulation bath of the quenching liquid. In another example, the quenching of an extruded fiber can involve exposing the extruded fiber to an atmosphere saturated with the quench liquid, followed by moving the extruded fiber into a coagulation bath of the quenching liquid. Exposing the shaped membrane precursor to a saturated atmosphere can be accomplished, for example, via a vapor diffusion chamber containing a vapor of the quench liquid, which may be, for example, water or an organic solvent.

The method of phase inversion can contribute to the pore size created in the hollow fiber membrane. Often, a vapor diffusion chamber may be needed to prepare ultrafiltration and nanofiltration membranes. In general, the extruded hollow fiber can be subjected to a vapor diffusion chamber quenching environment for anywhere between 30 seconds to 30 minutes, such as, 45seconds to 20 minutes, or 1 minute to 10 minutes, or 2 minutes to 8 minutes, again, depending on the solvents employed.

In embodiments, the quenching environment contains a liquid that is a non-solvent for the polymer or polymers in the fiber. The term non-solvent, when used in reference to a polymer, means a liquid that, when added to a solution of the polymer in a solvent, will cause phase separation of the solution at some concentration. The quench liquid can include, for example, water as the non-solvent, typically at between about 30 to about 90 wt. % of the quench liquid. The quench liquid can also include a solvent selected from any of the same solvents discussed with respect to the doping solution, including, for example, one or more of N,N-dimethyl formamide, cyclohexanone, tetrahydrofuran, methanol, acetone, isopropyl alcohol, N,N-dimethylacetamide, and dimethyl sulfoxide.

In an embodiment, the dope solution can be extruded into air. In an embodiment, the dope solution can be extruded into a coagulation bath.

After quenching, the prepared hollow fiber membrane can be washed to remove excess solvent and/or dried.

The hollow fiber membrane may also be subject to further processing. For example, in one embodiment, the hollow fiber membrane may be subjected to deposition processes to deposit a thin layer of a coating on the on the top of the hollow fiber membrane. Such deposition processes are known in the art, and include, for example, chemical vapor deposition and thin film deposition.

### Methods for Using the Hollow Fiber Membrane

The hollow fiber membrane can be employed in methods of treating effluent streams by filtering the effluent through the hollow fiber membrane. The effluent stream can be a gas in gas stream, a gas in liquid stream, a liquid in liquid stream, or a suspended solid in liquid stream. Generally, such effluent treating methods require the hollow fiber membrane to withstand pressures of from 0 to 1000 psi, or 0 to 500 psi.

In an embodiment, the effluent can be municipal wastewater. In some embodiments, the effluent can be industrial wastewater. The hollow fiber membranes may also be employed to purify drinking water and in food and alcohol purification. The hollow fiber membranes may also be employed to separate oil and water or a gas from a mixture of gases. The effluent can also be a biological stream, such as blood, protein, fermentation by-products, and the like.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

Additionally, as used herein, the term “substantially” means that a value of a given quantity is within ±10% of the stated value. In other embodiments, the value is within ±5% of the stated value. In other embodiments, the value is within ±2.5% of the stated value. In other embodiments, the value is within ±1% of the stated value.

The invention herein is useful for filtering effluent streams while exhibiting improved resistance to chemical degradation, which may be better understood with reference to the following examples.

### EXAMPLES

Hollow fiber membranes were prepared from dope solutions shown in Table 1 below.

TABLE 1
All numbers in phr

| | 1 | 2 | 3 | 4 | 5 | 6 | 7 | 8 |
|---|---|---|---|---|---|---|---|---|
| CPVC Resin | 20 | 16 | 18 | 18.9 | 14.5 | 16.5 | 18.5 | 18 |
| PVP Pore Former (40,000) | 6 | 6 | 6 | 10 | | | | |
| PEG Pore Former (2,000) | | | | | 8 | 4 | 5 | 6 |
| PEG₁₀₁/PPG₅₆/PEG₁₀₁ Pore Former | | | | | | 3 | | |
| TPU 1 - polyester 1300 MW soft TPU | 0 | 0 | 2 | | | | | |
| TPU 2 - hydrophilic polyether based 1000 MW TPU | | | | | | | 4 | 4 |
| NMP | 74 | 78 | 74 | 67.1 | 73.5 | 72.5 | 66.5 | 70 |
| Tin Stabilizer | | | | 2 | 2 | 2 | 2 | |
| Impact Modifier | | | | 2 | 2 | 2 | 2 | 2 |
| Anti-oxidant | | | | | | | 2 | |

The dope solutions were prepared by dissolving the chlorinated polyvinyl choride (CPVC) in the N-Methyl-2-Pyrrolidone (NMP). The CPVC was weighted and added to the NMP in a continuously stirred condition for 16 hours at 55° C. After dissolving the CPVC using this method, the additional formulation additives were added using the same continuously stirred conditions for 4 hours at 60° C.

For fabrication of the hollow fiber membranes from the aforementioned dope solutions, a typical hollow manufacturing apparatus was used for the fabrication process. The apparatus consisted of two reservoirs, a spinneret, a water bath and a winding unit. The fully formulated dope solution and a bore fluid were placed in separate reservoirs. The two fluids were pumped through a spinneret die that has channels cut into it for flow of the dope and bore fluid. This spinneret creates a 0.8 to 2mm diameter hollow fiber. The fiber was formed by the dope solution. The bore fluid was pumped from its reservoir through the spinneret to create the inside diameter of the fiber. The outside diameter of the fiber was created by the spinneret die's circular design and the free surface as the bore fluid exited the die. In the fabrication process, the spinneret was placed in a vertical position above the water bath and the two fluids exited the spinneret. A height above the water bath was specified to optimize the hollow fiber sizing parameters. Upon entering the water bath, the solvent was removed from the dope solution via phase inversion process. This phase inversion process created smaller pores in the hollow fiber. After completion of the fiber creation process, the fibers were washed in a water bath to remove excess solvent.

The fibers were tested for pore symmetry. Pore symmetry is a standard testing process for measurement of the pore diameters, average pore diameter, bubble point and pore size distribution created from the solvent based phase inversion process to create membranes. The membranes developed in these experiments were measured using the liquid-liquid pore-symmetry measurement process. In this test, a hollow fiber that has been wetted with water (wetting liquid) is placed in the test cell. The hollow fiber is then taken through a pressure gradient across the fiber wall where a second liquid called the displacement liquid flows through the membrane pores. The flow of this second liquid into and through the fiber wall provides the pore data. For these tests, the displacement liquid was isobutyl alcohol. The pore symmetry measurements for the hollow fiber membranes are provided in Table 2 below.

TABLE 2

| | 1 | 2 | 3 | 4 | 5 | 6 | 7 | 8 |
|---|---|---|---|---|---|---|---|---|
| Mean Flow Pore Pressure | 147.4 | 49.4 | 1.7 | 4.3 | 6.96 | 7.08 | 6.97 | 3.63 |
| (PSI) | | | | | | | | |
| Mean Flow Pore Diameter | 0.0048 | 0.0143 | 0.4098 | 0.164 | 0.101 | 0.0997 | 0.1 | 0.194 |
| (Microns) | | | | | | | | |
| Bubble Point Pressure | 28.03 | 2 | 1.16 | 3.92 | 5.2 | 4.13 | 4.98 | 2.02 |
| (PSI) | | | | | | | | |
| Bubble Point Pore Diameter | 0.0252 | 0.3529 | 0.606 | 0.18 | 0.135 | 0.171 | 0.142 | 0.349 |
| (Microns) | | | | | | | | |

Results from the hollow fiber testing indicate that hollow fibers with various pore sizes and pressure drops were created from the various dope solutions. In general, all hollow fiber tubes presented in this test matrix were capable of producing fibers with a pore size in the microfiltration (0.1 to 100 μm) to nanofiltration (0.001 to 0.1 μm) pore size range.

Tensile testing of the fibers was also completed per ASTM D638 at an elongation rate of 0.2 inches per minute, a gauge length of 2 inches, and a lab temperature of 23° C. Results of the tensile testing is provided in Table 3 below.

TABLE 3

| | 1 | 2 | 3 | 4 | 5 | 6 | 67 | 8 |
|---|---|---|---|---|---|---|---|---|
| Tensile modulus, psi | 21,752.0 | 16,656.0 | 26,524.0 | 18,208.0 | 16,164.0 | 10,043.0 | 23,137.0 | 23,105.0 |
| Stress at Break, psi | 765.0 | 587.0 | 832.0 | 791.0 | 527.0 | 402.0 | 698.0 | 832.0 |
| Strain at Break, % | 24% | 29% | 34% | 22% | 19% | 21% | 18% | 21% |
| Stran at Break Std. Dev. | 1.0 | 2.0 | 5.0 | 3.0 | 3.0 | 2.0 | 2.0 | 1.0 |
| Energy to Break, in*lbf | 0.6 | 0.6 | 1.0 | 0.8 | 0.3 | 0.3 | 0.4 | 0.6 |

% Improvement vs. 1 ctrl

| | | | | | | |
|---|---|---|---|---|---|---|
| Tensile modulus | 21.94% | −16.29% | −25.69% | −53.83% | 6.37% | 6.22% |
| improvement vs. 1 | | | | | | |
| Stress at break vs. 1 | 8.76% | 3.40% | −31.11% | −47.45% | −8.76% | 8.76% |
| Strain at break vs. 1 | 41.67% | 37.50% | −20.83% | −12.50% | −25.00% | −12.50% |
| Energy to Break vs. 1 | 67.67% | 39.50% | −47.33% | −55.17% | −30.17% | −7.17% |

% Improvement vs. 2 ctrl

| | | | | | | |
|---|---|---|---|---|---|---|
| Tensile modulus | 59.25% | 9.32% | −2.95% | −39.70% | 38.91% | 38.72% |
| improvemet vs. 2 | | | | | | |
| Stress at break vs. 2 | 41.74% | 34.75% | −10.22% | −31.52% | 18.91% | 41.74% |
| Strin at break vs. 2 | 17.24% | 13.79% | −34.48% | −27.59% | −37.93% | −27.59% |
| Energy to Break vs. 2 | 60.96% | 33.92% | −49.44% | −56.96% | −32.96% | −10.88% |

Results from the tensile testing indicate that the polyester TPU in experiment 3 provides the best tensile modulus, stress at break, elongation to break and energy at break versus the control 1 and 2 compounds. The experiments 7 and 8 uses a polyether (hydrophilic) TPU and provide improved tensile modulus, and stress at break versus the control compounds (1 & 2). Other experiments, like 4, had a higher strain at break due to the use of a resin with a lower chlorine level and also had a lower tensile modulus and not as high of a stress at break. This lower chlorine version will not have as high of temperature resistance properties due to the lower chlorine level in the base CPVC compound. In addition, the improvements in experiment 4 were not as significant as shown in experiment 3 with the TPU.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

A dope solution for preparing a hollow fiber membrane comprising at least one polymer of vinyl chloride, at least one thermoplastic polyurethane, at least one pore forming agent, and at least one solvent.

The dope solution of the previous sentence, wherein the pore forming agent comprises at least one of a phenol, salts of alkali metals, salts of alkaline earth metals, salts of transition metals or ammonium with halides or carbonates, polyvinyl pyrrolidone, polyethylene glycol, polyethylene-polyethylene oxide copolymer.

The dope solution of any previous sentence, wherein the pore forming agent is present at a concentration of from about 1 to about 20 wt. %.

The dope solution of any previous sentence, wherein the solvent comprises at least one of N-methyl pyrrolidone (NMP), N,N-dimethyl acetamide (DMAC), dimethyl formamide (DMF), methyl ethyl ketone (MEK), or methyl isobutyl ketone (MIBK), cyclohexanone, tetrahydrofuran, methanol, acetone, isopropyl alcohol, and dimethyl sulfoxide.

The dope solution of any previous sentence, where the solvent is present at a concentration of from about 25 to about 88.9 wt. %.

The dope solution of any previous sentence, wherein the (C)PVC is present at a concentration of from about 10 to about 40 wt. %.

The dope solution of any previous sentence, further comprising processing aids such as surfactants, drying agents, catalysts, co-solvents, such as polar aprotic solvents, or any combination thereof.

The dope solution of any previous sentence, wherein the processing aid is present at a concentration of from about 0.1 to about 10 wt. %.

The dope solution of any previous sentence, wherein the thermoplastic polyurethane polymer has an upright moisture vapor transmission rate (MVTR) of more than about 500 gms/m²/24 hr and comprises: (a) poly(alkylene oxide) side-chain units in an amount comprising about 29.9 wt. % to about 80 wt. % of said polyurethane, wherein (i) alkylene oxide groups in said poly(alkylene oxide) side-chain units have from 2 to 10 carbon atoms and are unsubstituted, substituted, or both unsubstituted and substituted, (ii) at least about 50 wt. % of said alkylene oxide groups are ethylene oxide, and (iii) said amount of said side-chain units is at least about 30 wt. % when the molecular weight of said side-chain units is less than about 600 grams/mole, and (b) poly(ethylene oxide) main-chain units in an amount comprising less than about 25 wt. % of said polyurethane.

A hollow fiber membrane comprising a hollow fiber extruded from the dope solution of any previous sentence.

A method for manufacturing a hollow fiber membrane comprising (a) preparing the dope solution of any previous sentence, (b) extruding the dope solution into a hollow fiber.

The method of any previous sentence, wherein the extrusion of step b) comprises extruding the dope solution through a spinneret.

The method of any previous sentence, wherein the dope solution is extruded into air.

The method of any previous sentence, further comprising cooling the hollow fiber after extrusion.

The method of any previous sentence, wherein the dope solution is extruded into a coagulant.

A method of treating an effluent stream, comprising filtering an effluent through a hollow fiber membrane prepared from a dope solution as set forth in any previous sentence.

A dope solution for preparing a porous hollow fiber membrane comprising at least one polymer of vinyl chloride, at least one pore forming agent, and at least one solvent.

The dope solution of the previous sentence, wherein the pore forming agent comprises at least one alkali metal salt.

The dope solution of any previous sentence, wherein the pore forming agent comprises at least one alkaline earth metal salt with a halide.

The dope solution of any previous sentence, wherein the pore forming agent comprises at least one alkaline earth metal salt with a carbonate.

The dope solution of any previous sentence, wherein the pore forming agent comprises at least one ammonium salt with a halide.

The dope solution of any previous sentence, wherein the pore forming agent comprises at least one ammonium salt with a carbonate.

The dope solution of any previous sentence, where the pore forming agent comprises at least one of ammonium chloride, calcium chloride, magnesium chloride, lithium chloride, sodium chloride, zinc chloride, calcium carbonate, magnesium carbonate, sodium carbonate, sodium bicarbonate and sodium citrate.

The dope solution of any previous sentence, wherein the pore forming agent comprises at least one phenol.

The dope solution of any previous sentence, wherein the pore forming agent comprises at least one phenol, ethylphenol, catechol, resorcinol, hydroquinone and methoxyphenol.

The dope solution of any previous sentence, wherein the pore forming agent comprises at least one polyvinyl pyrrolidone.

The dope solution of any previous sentence, wherein the pore forming agent comprises a polyethylene glycol.

The dope solution of any previous sentence, wherein the pore forming agent comprises at least one polyethylene-polyethylene oxide copolymer.

The dope solution of any previous sentence, wherein the pore forming agent comprises at least one hydroxyalkylcellulose polymer.

The dope solution of any previous sentence, where the pore forming agent has a molecular weight of from about 500 to about 100,000 daltons.

The dope solution of any previous sentence, where the pore forming agent has a molecular weight of from about 8000 to about 150,000 daltons.

The dope solution of any previous sentence, where the pore forming agent has a molecular weight of from about 40,000 to about 150,000 daltons.

The dope solution of any previous sentence, where the pore forming agent has a molecular weight of from about 8000 to about 40,000 daltons.

The dope solution of any previous sentence, where the pore forming agent comprises a poly(ethylene glycol)-block-poly(propylene glycol)-block-poly(ethylene glycol) copolymer having a molecular weight of from about 1000 to about 6000.

The dope solution of any previous sentence, where the pore forming agent comprises a poly(ethylene glycol)-block-poly(propylene glycol)-block-poly(ethylene glycol) copolymer having a molecular weight of from about 3000 to about 6000.

The dope solution of any previous sentence, where the pore forming agent comprises a poly(ethylene glycol)-block-poly(propylene glycol)-block-poly(ethylene glycol) copolymer pore forming agent having a molecular weight of from about 2000 to about 4000.

The dope solution of any previous sentence, where the pore forming agent comprises a poly(ethylene glycol)-block-poly(propylene glycol)-block-poly(ethylene glycol) copolymer pore forming agent having a molecular weight of from about 1000 to about 2000.

The dope solution of any previous sentence, where the pore forming agent comprises a polyethylene glycol having a molecular weight of from about 200 to about 20,000.

The dope solution of any previous sentence, where the pore forming agent comprises a polyethylene glycol having a molecular weight of from about 8000 to about 20,000.

The dope solution of any previous sentence, where the pore forming agent comprises a polyethylene glycol pore forming agent having a molecular weight of from about 200 to about 10,000.

The dope solution of any previous sentence, wherein the pore forming agent is present at a concentration of from about 1 to about 20 wt. % by weight of the dope solution.

The dope solution of any previous sentence, wherein the pore forming agent is present at a concentration of from about 2 to about 18 wt. % by weight of the dope solution.

The dope solution of any previous sentence, wherein the pore forming agent is present at a concentration of from about 4 to about 16 wt. % by weight of the dope solution.

The dope solution of any previous sentence, wherein the pore forming agent is present at a concentration of from about 5 to about 15 wt. % by weight of the dope solution.

The dope solution of any previous sentence, wherein the pore forming agent is present at a concentration of from about 5 to about 10 wt. % by weight of the dope solution.

The dope solution of any previous sentence, wherein the solvent comprises a polar aprotic solvent.

The dope solution of any previous sentence, wherein the solvent comprises N-methyl pyrrolidone (NMP).

The dope solution of any previous sentence, wherein the solvent comprises N,N-dimethyl acetamide (DMAC).

The dope solution of any previous sentence, wherein the solvent comprises dimethyl formamide (DMF).

The dope solution of any previous sentence, wherein the solvent comprises methyl ethyl ketone (MEK).

The dope solution of any previous sentence, wherein the solvent comprises methyl isobutyl ketone (MIBK).

The dope solution of any previous sentence, wherein the solvent comprises cyclohexanone.

The dope solution of any previous sentence, wherein the solvent comprises tetrahydrofuran.

The dope solution of any previous sentence, wherein the solvent comprises methanol.

The dope solution of any previous sentence, wherein the solvent comprises acetone.

The dope solution of any previous sentence, wherein the solvent comprises dimethyl sulfoxide.

The dope solution of any previous sentence, wherein the solvent comprises a polar protic solvent.

The dope solution of any previous sentence, wherein the solvent comprises isopropyl alcohol.

The dope solution of any previous sentence, where the solvent is present at a concentration of from about 25 to about 90 wt. %.

The dope solution of any previous sentence, where the solvent is present at a concentration of from about 25 to about 88.9 wt. %.

The dope solution of any previous sentence, where the solvent is present at a concentration of from about 30 to about 90 wt. %.

The dope solution of any previous sentence, where the solvent is present at a concentration of from about 30 to about 70 wt. %.

The dope solution of any previous sentence, where the solvent is present at a concentration of from about 35 to about 65 wt. %.

The dope solution of any previous sentence, where the solvent is present at a concentration of from about 40 to about 60 wt. %.

The dope solution of any previous sentence, where the (C)PVC has a chlorine content of from about 56 to about 72 wt. % based on the weight of the polymer.

The dope solution of any previous sentence, where the (C)PVC has a chlorine content of from about 58 to about 71 wt. % based on the weight of the polymer.

The dope solution of any previous sentence, where the (C)PVC has a chlorine content of from about 59 to about 70 wt. % based on the weight of the polymer.

The dope solution of any previous sentence, where the (C)PVC has a chlorine content of from about 56 to about 59 wt. % based on the weight of the polymer.

The dope solution of any previous sentence, where the (C)PVC has a chlorine content of from about 59.0 to about 72.0 wt. % based on the weight of the polymer.

The dope solution of any previous sentence, where the (C)PVC has a chlorine content of from about 60.0 to about 71.0 wt. % based on the weight of the polymer.

The dope solution of any previous sentence, where the (C)PVC has a chlorine content of from about 60.0 to about 70.0 wt. % based on the weight of the polymer.

The dope solution of any previous sentence, where the (C)PVC has a chlorine content of from about 63.0 to about 69 wt. % based on the weight of the polymer.

The dope solution of any previous sentence, where the (C)PVC has a chlorine content of from about 63.0 to about 68.0 wt. % based on the weight of the polymer.

The dope solution of any previous sentence, where the (C)PVC has a chlorine content of from about 64.0 to about 67.0 wt. % based on the weight of the polymer.

The dope solution of any previous sentence, where the (C)PVC has a chlorine content of from about 64.0 to about 65.0 wt. % based on the weight of the polymer.

The dope solution of any previous sentence, where the (C)PVC is prepared from a polyvinyl chloride resin having an inherent viscosity (“IV”) of about 0.4 to about 1.4 as measured per ASTM D1243.

The dope solution of any previous sentence, where the (C)PVC is prepared from a polyvinyl chloride resin having an inherent viscosity (“IV”) of about 0.6 to about 1.4 as measured per ASTM D1243.

The dope solution of any previous sentence, where the (C)PVC is prepared from a polyvinyl chloride resin having an inherent viscosity (“IV”) of about 0.5 to about 1.3 as measured per ASTM D1243.

The dope solution of any previous sentence, where the (C)PVC is prepared from a polyvinyl chloride resin having an inherent viscosity (“IV”) of about 0.54 to about 1.2 as measured per ASTM D1243.

The dope solution of any previous sentence, where the (C)PVC is prepared from a polyvinyl chloride resin having an inherent viscosity (“IV”) of about 0.6 to about 1.1 as measured per ASTM D1243.

The dope solution of any previous sentence, where the (C)PVC is prepared from a polyvinyl chloride resin having an inherent viscosity (“IV”) of about 0.65 to about 1.0 as measured per ASTM D1243.

The dope solution of any previous sentence, where the (C)PVC is prepared from a polyvinyl chloride resin having an inherent viscosity (“IV”) of about 0.65 to about 0.92 as measured per ASTM D1243.

The dope solution of any previous sentence, where the (C)PVC is prepared from a polyvinyl chloride resin having an inherent viscosity (“IV”) of about 0.65 to about 0.90 as measured per ASTM D1243.

The dope solution of any previous sentence, wherein the (C)PVC is present at a concentration of from about 10 to about 40 wt. % of the dope solution.

The dope solution of any previous sentence, wherein the (C)PVC is present at a concentration of from about 15 to about 30 wt. % of the dope solution.

The dope solution of any previous sentence, wherein the (C)PVC is present at a concentration of from about 18 to about 25 wt. % of the dope solution.

The dope solution of any previous sentence, further comprising processing aids.

The dope solution of any previous sentence, further comprising surfactant processing aids.

The dope solution of any previous sentence, further comprising drying agent processing aids.

The dope solution of any previous sentence, further comprising catalyst processing aids.

The dope solution of any previous sentence, further comprising co-solvent processing aids.

The dope solution of any previous sentence, further comprising polar aprotic co-solvent processing aids.

The dope solution of any previous sentence, wherein the processing aid(s) is present at a concentration of from about 0.1 to about 10 wt. %.

The dope solution of any previous sentence, wherein the processing aid(s) is present at a concentration of from about 0.5 to about 8 wt. %.

The dope solution of any previous sentence, wherein the processing aid(s) is present at a concentration of from about 1 to about 6 wt. %.

The dope solution of any previous sentence, further comprising a thermoplastic polyurethane polymer (“TPU”) comprising at least one polyisocyanate, at least one active hydrogen-containing compound, and optionally a chain extender.

The dope solution of any previous sentence, wherein the polyisocyanate of the TPU comprises hexamethylene-1,6-diisocyanate.

The dope solution of any previous sentence, wherein the polyisocyanate of the TPU comprises 2,2,4-trimethyl-hexamethylene-diisocyanate.

The dope solution of any previous sentence, wherein the polyisocyanate of the TPU comprises 2,4,4-trimethyl-hexamethylene diisocyanate.

The dope solution of any previous sentence, wherein the polyisocyanate of the TPU comprises di cyclohexylmethane diisocyanate.

The dope solution of any previous sentence, wherein the polyisocyanate of the TPU comprises isophorone diisocyanate.

The dope solution of any previous sentence, wherein the polyisocyanate of the TPU comprises tetramethyl xylylene diisocyanate.

The dope solution of any previous sentence, wherein the polyisocyanate of the TPU comprises toluene diisocyanate.

The dope solution of any previous sentence, wherein the hydrogen-containing compound of the TPU comprises a polyether polyol.

The dope solution of any previous sentence, wherein the hydrogen-containing compound of the TPU comprises a polycarbonate polyol.

The dope solution of any previous sentence, wherein the hydrogen-containing compound of the TPU comprises a polysiloxane polyol.

The dope solution of any previous sentence, wherein the hydrogen-containing compound of the TPU comprises an ethoxylated polysiloxane polyol.

The dope solution of any previous sentence, wherein the hydrogen-containing compound of the TPU comprises a polyester polyol.

The dope solution of any previous sentence, wherein the hydrogen-containing compound of the TPU comprises a poly(butanediol adipate).

The dope solution of any previous sentence, wherein the hydrogen-containing compound of the TPU comprises a hexane diol adipic acid polyester.

The dope solution of any previous sentence, wherein the hydrogen-containing compound of the TPU comprises a hexane diol isophthalic acid polyester.

The dope solution of any previous sentence, wherein the hydrogen-containing compound of the TPU comprises a poly(propylene glycol).

The dope solution of any previous sentence, wherein the hydrogen-containing compound of the TPU comprises a polytetrahydrofuran.

The dope solution of any previous sentence, wherein the hydrogen-containing compound of the TPU comprises a copolymers of poly(ethylene glycol) and poly(propylene glycol).

The dope solution of any previous sentence, wherein the hydrogen-containing compound of the TPU comprises the reaction of at least one of (A) 1,3-propanediol, 1,4-butanediol, 1,6-hexanediol, diethylene glycol, tri ethylene glycol, tetraethylene glycol, and mixtures thereof with (B) diarylcarbonates such as diphenylcarbonate or phosgene.

The dope solution of any previous sentence, wherein the hydrogen-containing compound of the TPU comprises the reaction of at least one of (A) aldehydes, such as formaldehyde and the like, and (B) glycols such as diethylene glycol, triethylene glycol, ethoxylated 4,4′-dihydroxy-diphenyldimethylmethane, 1,6-hexanediol, and the like and combinations thereof.

The dope solution of any previous sentence, wherein the hydrogen-containing compound of the TPU comprises a polyester amide.

The dope solution of any previous sentence, wherein the hydrogen-containing compound of the TPU comprises a polyamide.

The dope solution of any previous sentence, wherein the hydrogen-containing compound of the TPU comprises a side-chain prepared from alkylene oxides.

The dope solution of any previous sentence, wherein the hydrogen-containing compound of the TPU comprises less than about 25 wt. % poly(ethylene oxide) units in the backbone (main chain) based upon the dry weight of TPU.

The dope solution of any previous sentence, wherein the hydrogen-containing compound of the TPU comprises less than about 15 wt. % poly(ethylene oxide) units in the backbone (main chain) based upon the dry weight of TPU.

The dope solution of any previous sentence, wherein the hydrogen-containing compound of the TPU comprises less than about 5 wt. % poly(ethylene oxide) units in the backbone (main chain) based upon the dry weight of TPU.

The dope solution of any previous sentence, wherein the hydrogen-containing compound of the TPU comprises at least about 30 wt. % poly(ethylene oxide) units in the backbone (main chain) based upon the dry weight of TPU when the molecular weight of the side-chain units is less than about 600 grams/mole.

The dope solution of any previous sentence, wherein the hydrogen-containing compound of the TPU comprises at least about 15 wt. % poly(ethylene oxide) units in the backbone (main chain) based upon the dry weight of TPU when the molecular weight of the side-chain units is from about 600 to about 1,000 grams/mole.

The dope solution of any previous sentence, wherein the hydrogen-containing compound of the TPU comprises at least about 12 wt. % poly(ethylene oxide) units in the backbone (main chain) based upon the dry weight of TPU when the molecular weight of the side-chain units is greater than about 1,000 grams/mole.

The dope solution of any previous sentence, wherein the TPU comprises a hydrogen-containing compound of about 50 to about 10,000 grams/mole.

The dope solution of any previous sentence, wherein the TPU comprises a hydrogen-containing compound of about 200 to about 6,000 grams/mole.

The dope solution of any previous sentence, wherein the TPU comprises a hydrogen-containing compound of about 300 to about 3,000 grams/mole.

The dope solution of any previous sentence, wherein the TPU comprises the isocyanate and the active hydrogen-containing compound in a ratio of from about 1.3/1 to about 2.5/1.

The dope solution of any previous sentence, wherein the TPU comprises the isocyanate and the active hydrogen-containing compound in a ratio of from about 1.5/1 to about 2.1/1

The dope solution of any previous sentence, wherein the TPU comprises the isocyanate and the active hydrogen-containing compound in a ratio of from about 1.7/1 to about 2/1.

The dope solution of any previous sentence, wherein the TPU comprises a diethylene triamine chain extender.

The dope solution of any previous sentence, wherein the TPU comprises an ethylene diamine (EDA) chain extender.

The dope solution of any previous sentence, wherein the TPU comprises a meta-xylylenediamine (MXDA) chain extender.

The dope solution of any previous sentence, wherein the TPU comprises an aminoethyl ethanolamine (AEEA) chain extender.

The dope solution of any previous sentence, wherein the TPU comprises a 2-methyl pentane diamine propylene diamine chain extender.

The dope solution of any previous sentence, wherein the TPU comprises a butylene diamine chain extender.

The dope solution of any previous sentence, wherein the TPU comprises a hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, sulfonated primary and/or secondary amines hydrazine, substituted hydrazines, and hydrazine reaction products, and the like, and mixtures thereof. Suitable polyalcohols include those having from 2 to 12 carbon atoms, preferably from 2 to 8 carbon atoms, such as ethylene glycol, diethylene glycol, neopentyl glycol, butanediols, hexanediol, urea, hydrazine, chain extender.

The dope solution of any previous sentence, wherein the TPU comprises a cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, sulfonated primary and/or secondary amines hydrazine, substituted hydrazines, and hydrazine reaction products, and the like, and mixtures thereof. Suitable polyalcohols include those having from 2 to 12 carbon atoms, preferably from 2 to 8 carbon atoms, such as ethylene glycol, diethylene glycol, neopentyl glycol, butanediols, hexanediol, urea, hydrazine, chain extender.

The dope solution of any previous sentence, wherein the TPU comprises a phenylene diamine chain extender.

The dope solution of any previous sentence, wherein the TPU comprises a tolylene diamine chain extender.

The dope solution of any previous sentence, wherein the TPU comprises a 3,3-dichlorobenzidene chain extender.

The dope solution of any previous sentence, wherein the TPU comprises a 4,4′-methylene-bis-(2-chloroaniline chain extender.

The dope solution of any previous sentence, wherein the TPU comprises a 3,3-dichloro-4,4-diamino diphenylmethane chain extender.

The dope solution of any previous sentence, wherein the TPU comprises a sulfonated primary and/or secondary amine chain extender.

The dope solution of any previous sentence, wherein the TPU comprises a hydrazine chain extender.

The dope solution of any previous sentence, wherein the TPU comprises a polyalcohol chain extender having from 2 to 12 carbon atoms.

The dope solution of any previous sentence, wherein the TPU comprises a polyalcohol chain extender having from 2 to 8 carbon atoms.

The dope solution of any previous sentence, wherein the TPU comprises an ethylene glycol chain extender.

The dope solution of any previous sentence, wherein the TPU comprises a diethylene glycol chain extender.

The dope solution of any previous sentence, wherein the TPU comprises a neopentyl glycol chain extender.

The dope solution of any previous sentence, wherein the TPU comprises a butanediol chain extender.

The dope solution of any previous sentence, wherein the TPU comprises a hexanediol chain extender.

The dope solution of any previous sentence, wherein the TPU comprises a urea chain extender.

The dope solution of any previous sentence, wherein the TPU comprises a chain extender from about 0.5 to about 0.95 equivalents based on available isocyanate.

The dope solution of any previous sentence, wherein the TPU is present at a concentration of from about 0.1 to about 15 wt. % of the dope solution.

The dope solution of any previous sentence, wherein the TPU is present at a concentration of from about 0.5 to about 12 wt. % of the dope solution.

The dope solution of any previous sentence, wherein the TPU is present at a concentration of from about 1 to about 10 wt. % of the dope solution.

The dope solution of any previous sentence, further comprising a polyurethane polymer having an upright moisture vapor transmission rate (MVTR) of more than about 500 gms/m²/24 hr and comprising: (a) poly(alkylene oxide) side-chain units in an amount comprising about 29.9 wt. % to about 80 wt. % of said polyurethane, wherein (i) alkylene oxide groups in said poly(alkylene oxide) side-chain units have from 2 to 10 carbon atoms and are unsubstituted, substituted, or both unsubstituted and substituted, (ii) at least about 50 wt. % of said alkylene oxide groups are ethylene oxide, and (iii) said amount of said side-chain units is at least about 30 wt. % when the molecular weight of said side-chain units is less than about 600 grams/mole, and (b) poly(ethylene oxide) main-chain units in an amount comprising less than about 25 wt. % of said polyurethane.

A hollow fiber membrane comprising a fiber extruded from the dope solution of any previous sentence.

The hollow fiber membrane of the previous sentence, wherein the hollow fiber comprises pores suitable for microfiltration.

The hollow fiber membrane of any previous sentence, wherein the hollow fiber comprises pores ranging in size from about 0.1 to about 100 μm.

The hollow fiber membrane of any previous sentence, wherein the hollow fiber comprises pores ranging in size from about 0.5 to about 100 μm.

The hollow fiber membrane of any previous sentence, wherein the hollow fiber comprises pores ranging in size from about 1 to about 100 μm.

The hollow fiber membrane of any previous sentence, wherein the hollow fiber comprises pores suitable for ultrafiltration.

The hollow fiber membrane of any previous sentence, wherein the hollow fiber comprises pores ranging in size from about 0.01 to about 2 μm.

The hollow fiber membrane of any previous sentence, wherein the hollow fiber comprises pores ranging in size from about 0.1 to about 1 μm.

The hollow fiber membrane of any previous sentence, wherein the hollow fiber comprises pores suitable for nanofiltration.

The hollow fiber membrane of any previous sentence, wherein the hollow fiber comprises pores ranging in size from about 0.001 to about 0.5 μm.

The hollow fiber membrane of any previous sentence, wherein the hollow fiber comprises pores ranging in size from about 0.001 to about 0.1 μm.

The hollow fiber membrane of any previous sentence wherein the hollow fiber membrane comprises an asymmetric pore distribution.

The hollow fiber membrane of any previous sentence wherein the hollow fiber membrane comprises an integral skin layer.

The hollow fiber membrane of any previous sentence wherein the hollow fiber membrane does not include a skin layer.

A method for manufacturing a hollow fiber membrane comprising (a) preparing the dope solution of any previous sentence, (b) extruding the doping solution, (c) immersing the extruded dope solution in a quenching environment for a sufficient period to allow phase inversion.

The method of the previous sentence, wherein the quenching environment comprises a coagulation bath comprising water and a coagulation bath solvent

The method of any previous sentence, wherein the quenching environment comprises a vapor diffusion chamber.

The method of any previous sentence, wherein the quenching environment comprises a solvent diffusion chamber.

The method of any previous sentence, wherein the hollow fiber membrane is subjected to the solvent diffusion chamber for 30 seconds to 30 minutes.

The method of any previous sentence, wherein the temperature of the doping solution is maintained at about 20 to about 90° C.

The method of any previous sentence, wherein the coagulation bath comprises from about 30 to about 90 wt. % water.

A method of treating an effluent stream, comprising filtering an effluent through a hollow fiber membrane prepared from a dope solution as claimed in any previous sentence.

The method of the previous sentence, wherein the effluent stream comprises a gas in gas stream, a gas in liquid stream, a solid suspended in liquid, or a liquid in liquid stream.

The method of any previous sentence, wherein the hollow fiber membrane is subject to pressures of from 0 to 500 psi.

1. (canceled)

2. The hollow fiber membrane of claim 11, wherein the pore forming agent comprises at least one of a phenol, salts of alkali metals, salts of alkaline earth metals, salts of transition metals or ammonium with halides or carbonates, polyvinyl pyrroli done, polyethylene glycol, polyethylene-polyethylene oxide copolymer.

3. The hollow fiber membrane of claim 11, wherein the pore forming agent is present at a concentration of from about 1 to about 20 wt. %.

4. The hollow fiber membrane of claim 11, wherein the solvent comprises at least one of N-methyl pyrrolidone (NMP), N,N-dimethyl acetamide (DMAC), dimethyl formamide (DMF), methyl ethyl ketone (MEK), or methyl isobutyl ketone (MIBK), cyclohexanone, tetrahydrofuran, methanol, acetone, isopropyl alcohol, and dimethyl sulfoxide.

5. The hollow fiber membrane of claim 11, where the solvent is present at a concentration of from about 25 to about 88.9 wt. %.

6. The hollow fiber membrane of claim 11, wherein the (C)PVC is present at a concentration of from about 10 to about 40 wt. %.

7. The hollow fiber membrane of claim 11, further comprising processing aids such as surfactants, drying agents, catalysts, co-solvents, such as polar aprotic solvents, or any combination thereof.

8. The hollow fiber membrane of claim 11, wherein the processing aid is present at a concentration of from about 0.1 to about 10 wt. %.

9. The hollow fiber membrane of any previous sentence, wherein the thermoplastic polyurethane polymer comprises at least one polyisocyanate, at least one active hydrogen-containing compound, and optionally a chain extender.

10. The hollow fiber membrane of claim 11, wherein the thermoplastic polyurethane polymer has an upright moisture vapor transmission rate (MVTR) of more than about 500 gms/m²/24 hr and comprises: (a) poly(alkylene oxide) side-chain units in an amount comprising about 29.9 wt. % to about 80 wt. % of said polyurethane, wherein (i) alkylene oxide groups in said poly(alkylene oxide) side-chain units have from 2 to 10 carbon atoms and are unsubstituted, substituted, or both unsubstituted and substituted, (ii) at least about 50 wt. % of said alkylene oxide groups are ethylene oxide, and (iii) said amount of said side-chain units is at least about 30 wt. % when the molecular weight of said side-chain units is less than about 600 grams/mole, and (b) poly(ethylene oxide) main-chain units in an amount comprising less than about 25 wt. % of said polyurethane.

11. A hollow fiber membrane comprising a hollow fiber extruded from a dope solution comprising 10 to 40 wt. % of at least one polymer of vinyl chloride having a chlorine content of 63 to 72 wt. %; 0.1 to 15 wt. % of at least one thermoplastic polyurethane comprising at least one polyisocyanate, at least one active hydrogen-containing compound, and optionally a chain extender; at least one pore forming agent; and at least one solvent.

12. A method for manufacturing a hollow fiber membrane comprising
a) preparing a dope solution comprising 10 to 40 wt. % of at least one polymer of vinyl chloride having a chlorine content of 63 to 72 wt. %; 0.1 to 15 wt. % of at least one thermoplastic polyurethane comprising at least one polyisocyanate, at least one active hydrogen-containing compound, and optionally a chain extender; at least one pore forming agent; and at least one solvent,
b) extruding the dope solution into a hollow fiber.

13. The method of claim 12, wherein the extrusion of step b) comprises extruding the dope solution through a spinneret.

14. The method of claim 13, wherein the dope solution is extruded into air.

15. The method of claim 14, further comprising cooling the hollow fiber after extrusion.

16. The method of claim 13, wherein the dope solution is extruded into a coagulant.

17. A method of treating an effluent stream, comprising filtering an effluent through a hollow fiber membrane as claimed in claim 11.
